(19) United States
(12) Patent Application Publication
(10) Pub. No.: US 2026/0092496 A1
(43) Pub. Date: Apr. 2, 2026

(54) IMPROVED RETRACTABLE AND EXTENDABLE COVERING DEVICE

(71) Applicant: Unilux IP B.V., Boxtel (NL)

(72) Inventor: Thomas Pieter Christiaan HOEKMAN, Eindhoven (NL)

(73) Assignee: Unilux IP B.V., Boxtel (NL)

(21) Appl. No.: 19/110,693

(22) PCT Filed: Sep. 14, 2023
(86) PCT No.: PCT/NL2023/050477

§ 371 Date: Mar. 11, 2025

(30) Foreign Application Priority Data
Sep. 14, 2022 (NL) 2033027

(51) Int. Cl. E06B 9/54; E06B 9/262

(52) U.S. Cl. CPC E06B 9/54; E06B 9/262; E06B 2009/2625; E06B 2009/543

(57) ABSTRACT

Retractable and extendable covering device for an architectural opening, comprising:
first and second substantially parallel, in particular vertical, posts, each having a hollow interior, and at least one of the first and second posts being movable toward and away with respect to the other of the first and second posts;
a retractable and extendable substantially rectangular screen member having first and second pairs of opposite parallel edges and being mounted between the first and second parallel posts at the first pair of parallel edges;
a first flexible guide member coupled to the covering member and arranged to be at least partially moved into the hollow interior of the first post;

wherein the covering device further comprises a flexible covering member covering at least part of the first flexible guide member.

### TECHNICAL FIELD

The aspects and embodiments thereof relate to a retractable and extendable covering device for architectural openings. Such covering devices may be in the form of screens that enable ventilation while keeping out insect, but may also be useful in tempering sunlight.

### BACKGROUND

Various examples of such screening devices are known in the prior art, and one popular variation of insect screen uses a pleated screen to seal an architectural opening against the ingress of insects. This type of window screen does not need a spring for its retraction, and as a result can be operated with very little effort. Typically these screens, when installed at door openings, use flexible guide members, which are conveniently formed as a movable plastic caterpillar chain that allows a substantial reduction in height of the bottom guide rail, when the screen door is opened for access. The caterpillar chain disappears into the vertical operating profile and serves as a guide for the pleated screen when the screen is extended to cover the door opening.

WO2013015689 discloses a retractable and extendable covering device for architectural opening which can be mounted into an architectural opening with ease, requiring a limited number of parts.

### SUMMARY

Although the covering device of WO2013015689 already provides for an efficient and convenient covering device which enables ventilation through an architectural opening while keeping out insects, it is an object of the present disclosure to further improve one or more characteristics of a retractable and extendable covering device. In particular, it is an object to reduce the sound generated by the covering device when being retracted and/or extended and/or increase ease with which the covering device can be retracted and/or extended.

A first aspect provides a retractable and extendable covering device for an architectural opening according to claim 1.

When a flexible guide member of the covering device is at least partially covered by a flexible covering member, it is observed that sound generated by the covering device when retracting and/or extending the covering device is reduced. Sound may for example be reduced when the flexible covering member dampens vibrations of the flexible guide member, for example vibrations caused by relative movements between chain links comprised by the flexible guide members. In general, a flexible covering member may comprise or even consist of flexible and/or elastic material, such as one or more plastics, or any other flexible and/or elastic material.

In use, the flexible covering member may be positioned between the flexible guide member and a guide member deflector for deflecting the guide member. As such, the flexible covering member prevents or reduces contact between the flexible guide member and the guide member deflector, both of which are typically rigid members, for example comprising rigid materials such as one or more hard plastics or metals. The flexible covering member may form a continuous contacting surface instead of the discontinuous contacting surface in the flexible guide members of the known covering device due to the contacting surface being formed by surfaces of separate chain links.

A flexible guide member is generally defined as being flexible by virtue of the flexible guide member being able to change shape. As a particular example, the flexible guide member can change shape by virtue of the flexible guide member comprising a plurality of pivotally interconnected chain links. Additionally or alternatively, the shape of the flexible guide member may be changed by virtue of one or more internal degrees of freedom of the flexible guide member.

Preferably, at least part of the flexible guide member covered by the flexible covering member faces away from the screen member. In general, while retracting the covering device, the flexible guide member or at least part thereof may be moved or forced in a direction facing away from the screen member.

When the flexible guide member comprises a plurality of pivotally interconnected chain links, the flexible covering member may cover at least part of at least one of the chain links. In embodiments, the flexible covering member may even cover at least part of all chain links between two outer chain links of the flexible guide member. As an even further option, the flexible covering member may cover at least part of all chain links of the flexible guide member.

To connect the flexible covering member to move with the flexible guide member, the flexible covering member may be connected to at least one of the outer ends of the flexible guide member. Preferably, the at least one outer end is formed by an outer chain link of the flexible guide member.

As a particular option, applicable to any embodiment of the covering device, the flexible covering member may be connected to both outer ends of the flexible guide member. Preferably, the outer ends are formed by outer chain links of the flexible guide member.

It will be understood that throughout the present disclosure, an outer chain link of a flexible guide member may be a true outer chain link, or at least a functionally outer chain link. For example, the outer chain link may be defined by the fact that a flexible covering member is connected to said chain link.

Even when the flexible covering member is connected to move with the flexible guide member, the flexible covering member may be allowed to move relative to part of the flexible guide member in a direction parallel to an elongation direction of the flexible guide member, in particular relative to at least one chain link of the flexible guide member. Such movement may be required to accommodate the deformation of the flexible guide member in use of the covering device, for example when retracting or extending the covering device.

When the flexible guide member comprises chain links, at least one chain link may have a curved surface facing away from the screen member and part of the flexible covering member may lie over the curved surface. As such, the part of the flexible covering member may follow the curvature of the chain link. It may be preferred to have a curvature with a sufficiently large radius to prevent or reduce a chance of bending the flexible covering member over a too small radius. Furthermore, when the flexible guide member comprises chain links, at least one chain link may have a curved surface in use facing towards the flexible covering member.

When the covering device comprises at least one corner guiding member for guiding a movement of the flexible guide member, the flexible covering member may be at least partially positioned between the corner guiding member and the flexible guide member. As such, contact sound originating from contact between the flexible guide member and the corner guiding member may be reduced or direct contact between the flexible guide member and the corner guiding member may even be prevented.

A second aspect provides a chain link for a flexible guide member of a retractable and extendable covering device. the chain link comprises a central body having two faces on opposite sides of the central body, two side bodies connected at or near opposite sides of the central body, the side bodies being positioned at an angle relative to the faces of the central body, in particular substantially perpendicular, wherein at least one face of the central body is a curved face.

When the chain link has a curved face, the curved face may be used to dictate a particular curvature to a flexible covering device lying over the curved face. In general, the curved face may be a rigid surface, with a higher stiffness that the stiffness of the flexible covering device.

As an option applicable to any chain link disclosed herein, the side bodies may each comprise a groove arranged to accommodate part of a flat flexible covering member therein, wherein the grooves in the side bodies generally face towards each other. When at least part of the flexible covering member is positioned in the grooves, one or more degrees of freedom of the flexible covering member relative to the chain link may be restricted. Preferably, the grooves restrict a movement of the flexible covering member in a direction generally normal to the curved face. Additionally or alternatively, the grooves allow a movement of the flexible covering member in a direction along the curved face.

One face of the central body may be the curved face, and the other face of the central body may be a non-curved face.

A third aspect provides another chain link for a flexible guide member of a retractable and extendable covering device, the chain link being an outer chain link arranged to in use form a first or last chain link of a flexible guide member. The chain link comprises a central body having two faces on opposite sides of the central body and two side bodies connected at or near opposite sides of the central body, the side bodies being positioned at an angle relative to the faces of the central body, in particular substantially perpendicular. When the chain link further comprises a connection member for connecting a flexible covering member to, the flexible covering member can be connected to the chain link to move together with the chain link. It is preferred to connect the flexible covering member to at least one outer chain link. When the flexible covering member is connected to the two outer chain links of a flexible guide member, the flexible covering member may for example be tensioned between the outer links.

The connection member may protrude from one of the faces of the central body. When the connection member protrudes from the central body, as a further option, at least part of the central body may be a hingeable body portion which is hingeable relative to rest of the central body, and the connection member may be connected to the hingeable body portion. This may allow the flexible covering member to be non-rigidly connected to the central body.

When the chain link comprises the hingeable body portion, part of the hingeable body portion may be separated from the central body such that a slot is formed between said at least part of the hingeable body portion and the central body.

When the connection member of a chain link comprises a tension cord connector. one or more tension cords may be connected to said chain link. In general, for covering devices, one or more tension cords may be used to add stiffness to the screen member, which for example may be a mesh screen. Added stiffness may be desired for example to reduce movement and/or deformation of the mesh screen for example due to wind.

A fourth aspect provides a flexible guide member for a retractable and extendable covering device, for example but not limited to a covering device according to the first aspect. The flexible guide member comprises a plurality of pivotally interconnected chain links, wherein at least one of the chain links is a chain link according to the second aspect. Preferably, at least one of the first and the last chain link in the plurality of interconnected chain links is a chain link according to the third aspect.

According to the present disclosure, the flexible guide member may comprise a flexible covering member, covering at least one face of at least one central body. Preferably, but not necessarily, the flexible covering member is arranged to slide relative to at least one of the chain links. Further preferably, the flexible covering member is connected to at least one of the first and last chain link in the plurality of interconnected chain links.

### BRIEF DESCRIPTION OF THE FIGURES

In the figures,

FIGS. 1A-1D show an example of a covering device;

FIG. 2 shows a detailed view of part of a covering device;

FIG. 3A shows an embodiment of a flexible guide member;

FIG. 3B shows a detailed view of part of the flexible guide member;

FIG. 3C shows an exploded view of part of the flexible guide member;

FIG. 4A shows a section view of part of a flexible guide member;

FIG. 4B shows an example of a corner guiding member;

FIGS. 5A and 5B show an embodiment of a chain link respectively in an isometric view and a schematic section view;

FIG. 6A shows an exploded view of a chain link and part of a flexible covering member;

FIG. 6B shows part of a flexible guiding member;

FIG. 7A shows an example of an outer chain link; and

FIG. 7B shows part of a flexible covering member connected to an outer chain link.

### DETAILED DESCRIPTION OF THE FIGURES

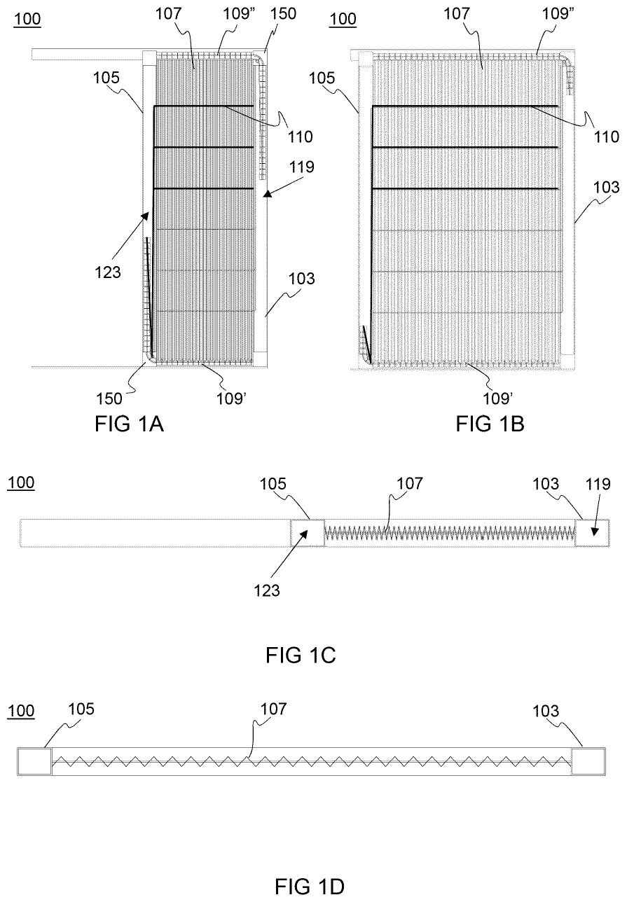

FIGS. 1A-1D show an example of a covering device 100, which can for example be a slidable insect screen or a sun screen for covering in its extended position an architectural opening, such as a window or door (not shown, but conventional). FIGS. 1A and 1B show a front view of the covering device 100, and FIGS. 1C and 1D show a top view of the covering device 100. FIGS. 1A and 1C show the covering device 100 in a partially open position, and FIGS. 1B and 1D show the covering device 100 in a closed position.

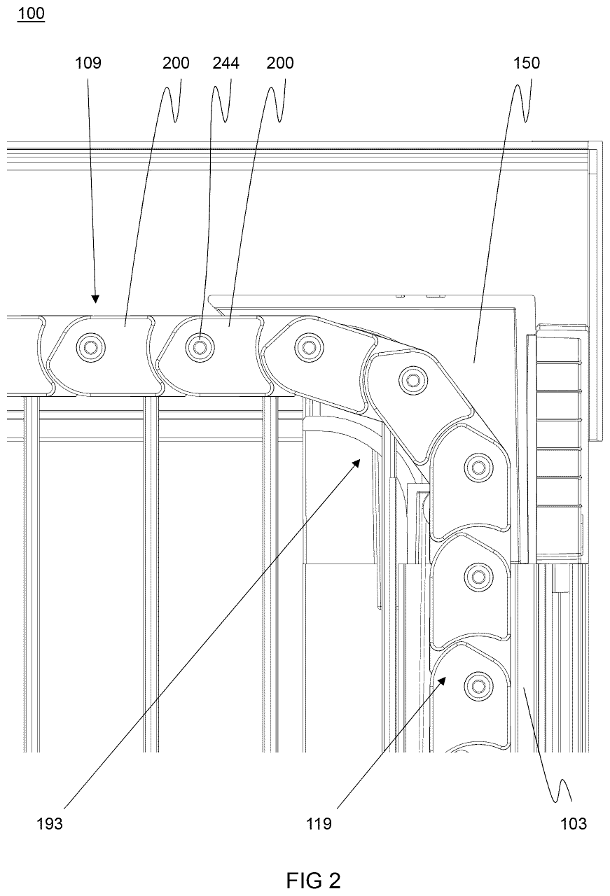

The covering device has a first vertical post 103 and a second vertical post 105, which posts are oriented substantially parallel to each other. A retractable screen member 107 extends between the two vertical posts 103, 105. The retractable screen member 107 may be attached to one or both of the posts 103, 105. A screen member may generally be arranged for blocking insects, and/or for at least partially blocking light such as sunlight. First and second flexible guide members 109 extend along horizontal edges of the screen member 107, or more in general the edges of the screen member not attached to the vertical posts. The guide members each comprises a plurality of individual chain links 200 that are articulated to one another by a pivot connection, which may also be referred to as a hinge connection. In general, a pivot connection allows a single rotational degree of freedom between pivotally connected chain links. Optionally, a translational degree of freedom may also be allowed between connected chain links. The chain links 200 will be elaborated on further in conjunction with FIGS. 2-7B. In use, while the covering device 100 is opened or closed—i.e. retracted or extended—the chain links 200 allow the flexible guide members to change in shape. In other words, the guide members 109 are flexible in shape by virtue of the hinged connection between the chain links 200.

The first flexible guide member 109′is connected to the bottom of the first post 103. The second flexible guide member 109″ is connected to the top of the second post 105. When the covering device 100 is retracted—for example from the state of FIG. 1B to the state of FIG. 1A, the first flexible guide member 109′ moves further into a hollow guiding portion 123 formed by a hollow interior of the second post 105 and the second guide member 109″ moves further into a hollow guiding portion 119 formed by a hollow interior of the first post 103.

It will be understood that embodiments of the covering device 100 are envisioned wherein the vertical posts 103 and 105 are not vertical, but instead are oriented horizonal or conceivably in any other orientation between vertical and horizontal.

As schematically indicated in FIGS. 1A and 1B, the covering device 100 comprises one or more tension cords 110. In particular, the covering device may comprise two sets of one more tensions cords, each set associated with one of the posts 103, 105. For clarity and conciseness of the figures, only tension cords of a first set of tension cords are highlighted in FIG. 1A.

The first set of tension cords is connected to the first flexible guide member 109′. This allows the tension cords to remain tensioned regardless of the retractable screen member 107 being extended, retracted, or somewhere in-between the extended and retracted states. The first set of tension cords is generally connected to the first flexible guide member 109′ at an opposite end to where the first flexible guide member 109′ is connected the first post 103.

FIG. 2 shows a detailed view of part of a covering device 100, in particular the right-hand top corner of the covering device 100 shown in FIG. 1A. In the detail view, the covering device 100 is shown comprising a corner guiding member 150. As indicated in FIG. 1A, embodiments of the covering device 100 may comprise multiple corner guiding members 150, for example one in the bottom left corner and one in the top right corner. In use, the corner guiding member 150 guides the movement of a flexible guide member 109. The flexible guide member 109 is in FIG. 2 shown comprising a plurality of pivotally connected chain links 200.

In use, as the screen member 107 of the covering device is opened further, the flexible guide member 109 moves further into the hollow guiding portion 119 of the vertical post 103. To move further into the hollow guiding portion 119, the flexible guide member 109 has to change shape-in other words, a curved portion 193 of the flexible guide member 109 comprises different chain links as the flexible guide member moves further into the hollow guiding portion 119.

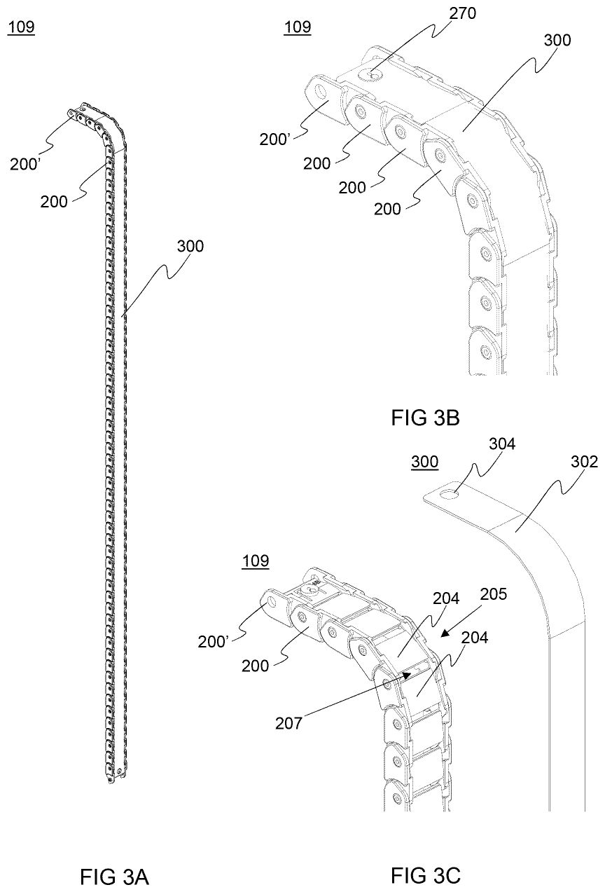

As the screen member 107 is opened further, and the flexible guide member 109 thus moves further into the hollow guiding portion 119 of the vertical post 103, part of the flexible guide member 109 may be pushed against the corner guiding member 150. Due to the flexible guide member 109 engaging the corner guiding member 150, the corner guiding member 150 is used to guide the movement of the flexible guide member 109. It has been observed that the flexible guide member 109 contacting the corner guiding member 150 may cause undesired noise. To decrease or even eliminate this noise, the present disclosure contemplates the use of a flexible covering member, as will be explained in conjunction with FIGS. 3A-7B, which flexible covering member is preferably positioned between the flexible guide member 109 and the corner guiding member 150.

Thus, to allow the flexible covering member to reduce sound or noise otherwise generated by direct contact between the flexible guide member 109 and the corner guiding member, the flexible covering member is preferably at least partially positioned in-between at least part of the flexible guide member 109 and at least part of the corner guiding member 150. This can be achieved for example when at least part of the flexible guide member 109 covered by the flexible covering member 300 faces away from the screen member 107.

FIG. 3A shows an embodiment of a flexible guide member 109 which is partially covered by a flexible covering member 300. FIG. 3B shows a detailed view of part of the flexible guide member 109, and FIG. 3C shows an exploded view of part of the flexible guide member 109 and part of the flexible covering member 300.

As depicted in FIG. 3A, it is envisioned that the flexible covering member 300 covers at least part of at least one of the chain links 200 comprised by the flexible guide member 109. Preferably, but not necessarily, the flexible member 300 covers at least part of all chain links 200 between two outer chain links of the flexible guide member 109. Even more preferably, but also not necessarily, the flexible covering member 300 covers at least part of all chain links 200 of the flexible guide member 109. In general, it is preferred that the flexible covering member 300 covers at least those parts of the flexible guide member 109 which may contact other parts of the covering device 100, in particular the corner guiding member 150.

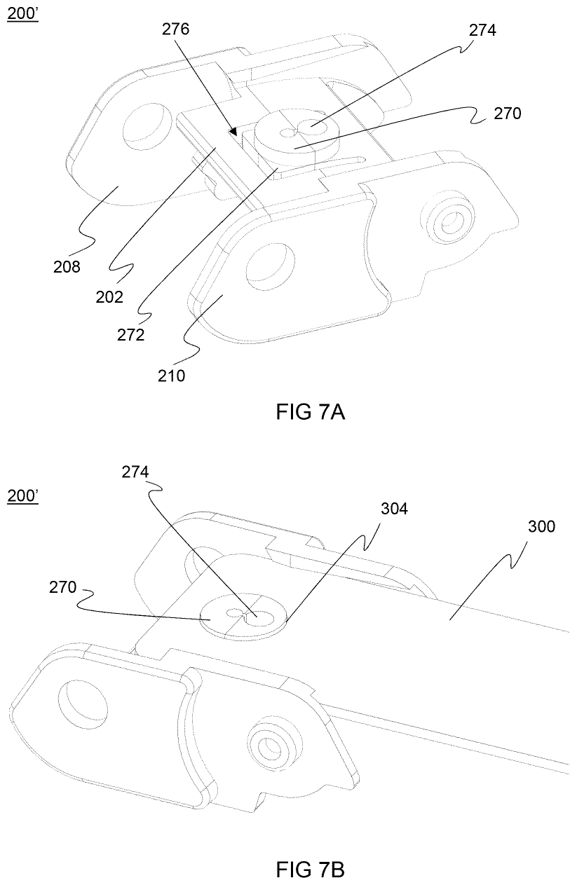

In general, for any embodiment of the flexible guide member 109, the flexible covering member 300 can be connected to any one chain link 200, or to any plurality of chain links 200, in any combination. However, it may be preferred to connect the flexible guide member 109 to at least one or even both outer chain links. The outer chain links will be further elaborated on in conjunction with FIGS. 7A and 7B.

In particular from the exploded view of FIG. 3C, it becomes apparent that an outward facing surface 205 of the flexible guide member 109—without the flexible covering member 300—may be substantially non-smooth as the outward facing surface 205 is formed by outer faces 204 of the chain links 200. Between outer faces 204 of adjacent chain links 200, typically a spacing 207 is present which may be required to allow the pivoting movement between adjacent pivotally connected chain links.

Preferably, the flexible covering member 300 covers at least one of the spacings 207 between adjacent chain links 200 of the flexible guide member 109, and therefor increases the smoothness of the part of the flexible guide member 109 which in use contacts other parts of the covering device 100, in particular the corner guiding member 150. Preferably, the flexible covering member 300 covers the majority or even all spacings 207 present between chain links 200 of the flexible guide member 109.

The flexible covering member 300 has an outward facing surface 302, which in use faces away from the screen member 107. In use, part of the flexible covering member 300 may contact a corner guiding member 150. As the flexible guide member 109 to which the flexible covering member 300 is connected moves further into and/or further out of the hollow interior of a post, part of the flexible covering member 300 may rub against the corner guiding member 150. Without the flexible covering member 300 present, the outer faces 204 of the chain links 200 may have rubbed against or contacted the corner guiding member 150. In particular with the spacings 207 present between adjacent chain link 200, this rubbing or contacting may cause unwanted noise such as rattling.

In general, applicable to any embodiment of the covering device and flexible guide member, the flexible covering member 300 may comprise or consist of softer and/or more elastic material and/or geometry than the material forming the outer faces 204 of the chain links 200. Additionally or alternatively, the flexible covering member 300 may comprise or consist of softer and/or more elastic material than the material forming the curved guiding surface 151 of the corner guiding member 150.

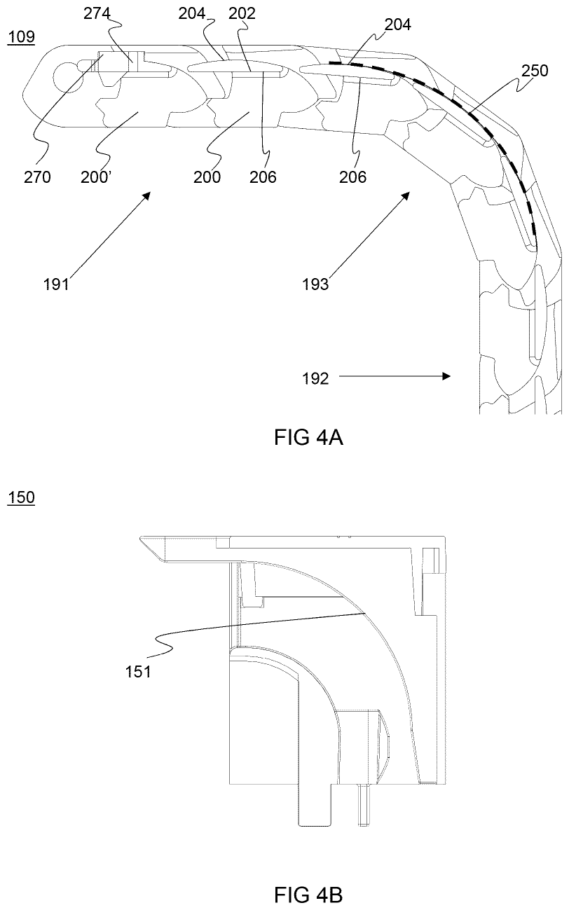

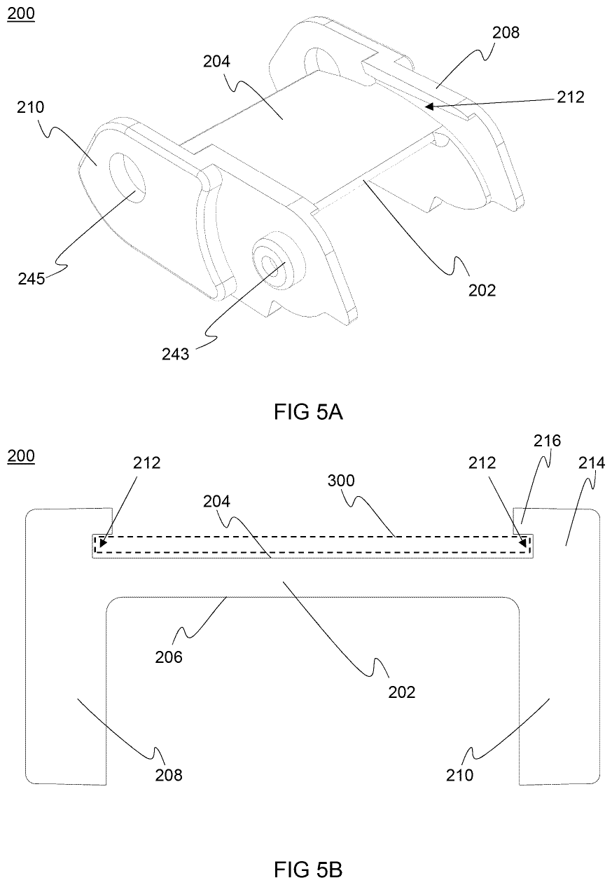

FIG. 4A shows a section view of part of a flexible guide member 109 comprising a plurality of interconnected chain links 200. As depicted in FIG. 4A, any chain link 200 disclosed herein may comprise a central body 202 with a curved first face 204, opposite to a second face 206 which may be flat or curved. When multiple adjacent chain links have central bodies with curved faces 204, the curved faces 204 may generally form part of a larger curvature 250 (depicted as a dashed line in FIG. 4A). The larger curvature 250 is preferably part of a circle—i.e. the curvatures of the curved faces 204 are essentially similar and have the same radius. The chain links 200 will be further elaborated on in conjunction with FIGS. 5A and 5B.

As depicted, in general, in use of a covering device 100, the flexible guide member 109 may have a horizontal portion 191, a vertical portion 192, and a curved portion 193 in between the horizontal portion 191 and the vertical portion 192. Any of the horizontal portion, vertical portion, and curved portion may be formed by one or more chain links 200. In the example of FIG. 4A, the curved portion 193 is generally formed by three chain links 200. Depending on the dimensions of the chain links and the dimensions of the covering device, in other embodiments, the curved portion 193 may be formed by one, two, or even four or more chain links. In use, at least part of the vertical portion 192 may be positioned in the hollow interior of a post. As the covering device 100 is retracted or extended, different chain links may form the curved portion 193. Preferably, both the horizontal portion 191 and the vertical portion 192 always comprise at least one chain link, regardless of the state of the covering device.

FIG. 4B shows an example of a corner guiding member 150 which may be comprised by any covering device 100 disclosed herein. The corner guiding member 150 can for example be connected at a top side of a post, such as the vertical post 103 depicted in FIGS. 1A and 1B, and/or at a bottom side of a post, such as the vertical post 105 depicted in FIGS. 1A and 1B.

The corner guiding member 150 comprise a curved guiding surface 151 which is use guides the flexible guide member 109 as the covering device 100 is extended or retracted. In use, the curvature of the curved guiding surface 151 and the curvature 250 formed by the one or more faces 204 of the chain links may correspond to each other. Corresponding curvatures may for example be defined by a similar radius, for example when the radius of the curved guiding surface 151 and the curvature 250 formed by the one or more faces 204 of the chain links deviates no more than 25%, preferably no more than 10% or even no more than 5%.

FIGS. 5A and 5B show an embodiment of a chain link 200 respectively in an isometric view and a schematic section view. The chain link 200 may be used to form part of a flexible guide member of any covering device disclosed herein.

The chain link 200 comprises a central body 202 which has two faces 204, 206 on opposite sides of the central body 202. Two side bodies 208, 210 are connected at opposite sides of the central body, which side bodies 208, 210 are generally oriented at an angle relative to the faces 204, 206 of the central body 202 and in the particular embodiment of FIGS. 5A and 5B oriented substantially perpendicular to the faces 204, 206 of the central body 202. The side bodies 208, 210 hence form flanges for the central body which is positioned between the side bodies 208, 210.

As shown in FIG. 5A, and further in the disclosure in conjunction with FIG. 4A, one of the faces 204 is a curved face. As a further option, the other face 206 of the central body 202 can be a flat face, or conceivably can also be curved. Preferably, the entire face 204 is a curved face, or at least a majority of the face 204 is curved.

As best depicted in FIG. 5B, the side bodies 208, 210 may comprise a groove 212 arranged to accommodate part of a flat flexible covering member 300 (schematically shown hatched in FIG. 5B). The groove 212 is formed by an upward protruding portion 214 extending beyond the face 204 of the central body 202, and a thickened side body portion 216 which extends toward the other of the side bodies. When the central body 202 comprises two grooves, one per side body, the grooves 212 face each other.

In use, lateral movement of the flexible covering member may be restricted or even prevented by virtue of the side bodies 208, 210. Movement of the flexible covering member towards the second face 206 of the central body 212 may be prevented or restricted by the central body 212 itself, and movement of the flexible covering member away from the first face 204 may be prevented or restricted by virtue of the grooves 212, in particular the thickened side body portion 216.

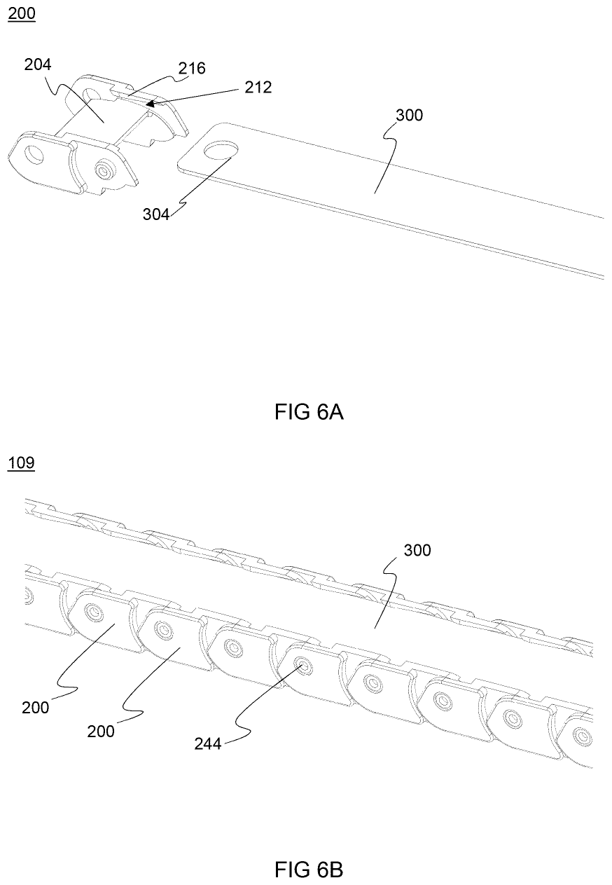

To allow a pivotal interconnection of a plurality of chain links 200, the chain link 200 comprises at least one male pivoting member 243 and at least one female pivoting member 245. When mated, a male pivoting member of a first chain link and a female pivoting member of a second chain link may together form a pivoting joint allowing a pivoting movement between the first chain link and the second chain link. An example of a pivoting joint 244 is indicated in FIG. 2 and FIG. 6B. The male pivoting members 243 and female pivoting members 245 are generally provided by on the side bodies 208, 210 and face away from the central body 202.

FIG. 6A shows an exploded view of a chain link 200 and part of a flat flexible covering member 300. To assembly the chain links and the flexible covering member 300 to form a flexible guiding member 109, the flexible covering member 300 may be positioned in the grooves 212 of the chain links by virtue of a relative movement between the chain links and the flexible covering member 300. FIG. 6B shows part of a flexible guiding member 109 comprising a plurality of interconnected chain links 200, which are partially covered by the flexible covering member 300.

FIG. 7A shows an example of an outer chain link 200′. The outer chain link 200′is partially similar to the chain link 200 for example disclosed in FIG. 5A—i.e. the outer chain link 200′ comprises a central body 202 and two side bodies 208, 210. The outer chain link 200′ however comprises a connection member 270 for connecting a flexible covering member to. The connection member 270 is as an option depicted in FIG. 7A formed as a protrusion protruding from the central body 202. In general, an outer chain link 200′ can preferably be pivotally connected to any other chain link 200 as disclosed herein.

Typically, chain links 200 which are not outer chain links are connected to two adjacent chain links. However, for outer chain links 200′, typically only a connection to one adjacent chain link is required. As such, an outer chain link 200′ may in embodiments only comprise one or more male pivoting members 243 or one or more female pivoting member 245.

FIG. 7B shows part of a flexible covering member 300 connected to an outer chain link 200′. For example when the outer chain link 200′ comprises the protrusion 270 as the connection member, the flexible covering member 300 can be connected to the protrusion 270 and thus to the outer chain link 200′. In the embodiment of FIG. 7B, the flexible covering member 300 comprises a through-hole 304 sized to in use accommodate the protrusion 270. The through-hole 304 is also indicated in FIG. 3C.

An optional feature shown in FIG. 7A is that part of the central body 202 is a hingeable part 272. The hingeable part 272 is hingeable relative to the central body 202, and as the protrusion 270 protrudes from said hingeable part 272, the protrusion 270 or other type of connection member may thus be hingeable relative to the central body 202. In particular, a slot 276 may be formed around part of the hingeable part 272, even more in particular around three sides of the hingeable part 272. The protrusion 270 is generally hingeable towards the flexible covering member 300 or the protrusion 270 is hingeable away from the flexible covering member 300. The hingeable part 272 may be hingeable through a living hinge. The through-hole 304 may have to be elastically deformed to fit around the protrusion 270.

Preferably, but not necessarily, as depicted in FIGS. 7A-7B, the connection member 270 comprises a tension cord connector 274 for connecting one or more tension cords 110 to. It will be appreciated that in general, tension cords 110 may be connected to an outer chain link 200′, but conceivably also to any other chain link 200. As such, a tension cord connector 274 may also be comprised by any other chain link 200, for example such that one or more tension cords can be connected to a central body 202 of any chain link disclosed herein.

In the description above, it will be understood that when an element is referred to as being connect to another element, the element is either directly connected to the other element, or intervening elements may also be present. Also, it will be understood that the values given in the description above, are given by way of example and that other values may be possible and/or may be strived for.

It is to be noted that the figures are only schematic representations of embodiments that are given by way of non-limiting examples. For the purpose of clarity and a concise description, features are described herein as part of the same or separate embodiments, however, it will be appreciated that the scope of the disclosure may include embodiments having combinations of all or some of the features described.

The word ‘comprising’ does not exclude the presence of other features or steps. Furthermore, the words ‘a’ and ‘an’ shall not be construed as limited to ‘only one’, but instead are used to mean ‘at least one’, and do not exclude a plurality.

1. A retractable and extendable covering device for an architectural opening, comprising:
first and second substantially parallel, in particular vertical, posts, each having a hollow interior, and at least one of the first and second posts being movable toward and away with respect to the other of the first and second posts;
a retractable and extendable substantially rectangular screen member having first and second pairs of opposite parallel edges and being mounted between the first and second parallel posts at the first pair of parallel edges;
a flexible guide member coupled to the screen member and arranged to be at least partially moved into the hollow interior of the first post;
wherein the covering device further comprises a flexible covering member covering at least part of the flexible guide member.

2. The covering device according to claim 1, wherein the at least part of the flexible guide member covered by the flexible covering member faces away from the screen member.

3. The covering device according to claim 1, wherein the flexible guide member comprises a plurality of pivotally interconnected chain links, and the flexible covering member covers at least part of at least one of the chain links.

4. The covering device according to claim 3, wherein the flexible covering member covers at least part of all chain links between two outer chain links of the flexible guide member.

5. The covering device according to claim 3, wherein the flexible covering member covers at least part of all chain links of the flexible guide member.

6. The covering device according to claim 1, wherein the flexible covering member is connected to at least one of the outer ends of the flexible guide member.

7. The covering device according to claim 1, wherein the flexible covering member is connected to both outer ends of the flexible guide member.

8. The covering device according to claim 1, wherein the flexible covering member is allowed to move relative to part of the flexible guide member in a direction parallel to an elongation direction of the flexible guide member.

9. The covering device according to claim 3, wherein at least one chain link has a curved surface facing away from the screen member and part of the flexible covering member lies over the curved surface.

10. The covering device according to claim 1, further comprising at least one corner guiding member for guiding a movement of the flexible guide member, and wherein the flexible covering member is at least partially positioned between the corner guiding member and the flexible guide member.

11. A chain link for a flexible guide member of a retractable and extendable covering device, the chain link comprising:
a central body having two faces on opposite sides of the central body;
two side bodies connected at or near opposite sides of the central body, the side bodies being positioned at an angle relative to the faces of the central body, in particular substantially perpendicular;
wherein at least one face of the central body is a curved face.

12. A chain link according to claim 11, wherein the side bodies each comprise a groove arranged to accommodate part of a flat flexible covering member therein, wherein the grooves in the side bodies face towards each other.

13. (canceled)

14. A chain link for a flexible guide member of a retractable and extendable covering device, the chain link being an outer chain link arranged to in use form a first or last chain link of a flexible guide member, the chain link comprising:
a central body having two faces on opposite sides of the central body; and
two side bodies connected at or near opposite sides of the central body, the side bodies being positioned at an angle relative to the faces of the central body, in particular substantially perpendicular;
wherein the chain link further comprises a connection member for connecting a flexible covering member to.

15. The chain link according to claim 14, wherein the connection member protrudes from one of the faces of the central body.

16. (canceled)

17. (canceled)

18. The chain link according to claim 14, wherein the connection member comprises a tension cord connector for connecting one or more tension cords to.

19. A flexible guide member for a retractable and extendable covering device, comprising a plurality of pivotally interconnected chain links, wherein at least one of the chain links is a chain link according to claim 11.

20. The flexible guide member according to claim 19, wherein at least one of the first and the last chain link in the plurality of interconnected chain links is a chain link according to claim 14.

21. The flexible guide member according to claim 19, further comprising a flexible covering member, covering at least part of at least one face of at least one central body.

22. The flexible guide member according to claim 21, wherein the flexible covering member is arranged to slide relative to at least one of the chain links.

23. The flexible guide member according to claim 21, wherein the flexible covering member is connected to at least one of the first and last chain link in the plurality of interconnected chain links.
